(19) United States
(12) Patent Application Publication
(10) Pub. No.: US 2026/0074129 A1
(43) Pub. Date: Mar. 12, 2026

(54) SWITCHING UNIT FOR ELECTRICAL APPLICATIONS

(71) Applicant: ABB Schweiz AG, Baden (CH)

(72) Inventors: Carlo Boffelli, Dalmine (IT); Fabio Giacalone, Almè (BG) (IT); Giorgio Forlani, Romano di Lombardia (BG) (IT)

(21) Appl. No.: 19/262,547

(22) Filed: Jul. 8, 2025

(30) Foreign Application Priority Data
Sep. 6, 2024 (EP) 24198808.8

(51) Int. Cl. H01H 33/666

(52) U.S. Cl. CPC H01H 33/666

(57) ABSTRACT

The present disclosure relates to a switching unit. The switching unit includes a pair of switching poles electrically connected in series. Each switching pole comprises a vacuum interruption chamber housing a fixed contact and a movable contact moving between an open position in which it is separated from the fixed contact and a closed position in which it is electrically coupled to the fixed contact. The switching unit further comprises an improved drive assembly operatively coupled to the movable contacts of the switching poles to actuate said movable contacts.

### CROSS REFERENCE TO RELATED APPLICATIONS

The present application claims priority to European Patent Application No. 24198808.8 filed on Sep. 6, 2024, and titled “A SWITCHING UNIT FOR ELECTRICAL APPLICATIONS”, which is hereby incorporated by reference in its entirety.

### TECHNICAL FIELD

The present disclosure relates to a switching unit for electrical applications. More particularly, the present disclosure relates to a switching unit including a pair of switching poles electrically connected in series and equipped with an improved drive assembly for operating the movable contacts of the switching poles.

### BACKGROUND

Switching units are often particularly adapted for being employed in switching apparatuses installed in medium voltage electrical systems, for example in medium voltage switchgears, switchboards, or electric grids.

Switching apparatuses including switching poles based on vacuum interruption technology are well known in the field of electrical systems.

As is known, when they are intended to operate at relatively high voltage levels (for example about 72 kV), switching apparatuses of this type may comprise, for each electric phase, a switching unit including a pair of switching poles electrically connected in series.

Examples of this kind of switching unit are disclosed in EP23189111.0.

The switching unit comprises a drive assembly to actuate the movable contacts of the switching poles during a closing maneuver or an opening maneuver.

Typically, such a drive assembly comprises a drive shaft moving along a translation axis and a toggle knee mechanism operatively coupled to the drive shaft and to kinematic chains operatively coupled to the movable contacts of the switching poles.

During a closing maneuver or an opening maneuver, the toggle knee mechanism is actuated by first translational mechanical forces provided by the drive shaft and provide corresponding second translational mechanical forces (normally directed perpendicularly to said first translational mechanical forces) to actuate the movable contacts of the switching poles.

Currently available switching units of this type still have some aspects to improve.

Due to the geometric configuration of the toggle knee mechanism, the moving components (in particular the pushrods) of the switching poles are often subject to intense undesired mechanical forces directed perpendicularly to the translation axis of the movable contacts during a closing maneuver or an opening maneuver.

These undesired lateral force components may cause the arising of severe wear phenomena in the moving components the switching poles.

Such an inconvenient remarkably reduces the operating life of the switching unit and, in general, entails a partial dissipation of the mechanical energy provided by the drive shaft to operate the movable contacts of the switching poles.

Additionally, since the switching unit may be subject to relevant vibrations and backslashes during a closing maneuver or an opening maneuver, cumbersome and robust fixation arrangements are needed to fix the switching poles on a suitable supporting structure. This can sometimes make rather problematic the installation of the switching unit in electrical systems where installation spaces are often narrow.

### BRIEF DESCRIPTION

The main aim of the present disclosure is to provide a switching unit for electrical applications, which allows overcoming or mitigating the above-mentioned drawbacks of the known art.

Within this aim, a purpose of the present disclosure is to provide a switching unit having a simple and compact structure with a relatively small size.

A further purpose of the present disclosure is to provide a switching unit, in which wear phenomena in the moving components of the switching poles are remarkably reduced in comparison to traditional solutions of the state of the art.

A further purpose of the present disclosure is to provide a switching unit, which is relatively install on the field, even in limited installation spaces.

A further purpose of the present disclosure is to provide a switching unit, in which vibrations and backslashes are remarkably reduced during a closing maneuver or an opening maneuver.

A further purpose of the present disclosure is to provide a switching unit, which is relatively simple and cheap to manufacture at industrial levels.

In a general definition, the switching unit, according to the present disclosure, comprises a pair of switching poles electrically connected in series.

Each switching pole comprises first and second pole terminals and a vacuum interruption chamber including a fixed contact electrically connected to said first pole terminal and a movable contact electrically connected to said second pole terminal.

The movable contact of each switching pole is movable along a translation axis between an open position, in which it is separated from the fixed contact, and a closed position, in which it is electrically coupled to the fixed contact.

When it is in said closed position, the movable contact of each switching pole can be subject to a mechanical load forcing it against the fixed contact.

Each switching pole further comprises a motion transmission assembly placed outside the vacuum interruption chamber and operatively coupled to the movable contact and a pushrod operatively coupled to said motion transmission assembly.

According to the present disclosure, the switching unit further comprises a drive assembly comprising a drive shaft rotating about a rotation axis during a closing maneuver or an opening maneuver of said switching unit and a plurality of eccentric mechanisms, each operatively coupled to said drive shaft and to the pushrod of a respective switching pole.

Each eccentric mechanism is actuated by rotational mechanical forces provided by said drive shaft and provides corresponding translational mechanical forces to the pushrod of the corresponding switching pole to actuate the movable contact of said switching pole during a closing maneuver or an opening maneuver of said switching unit.

Advantageously, the switching unit, according to the present disclosure, comprises a drive actuator operatively coupled the drive shaft of the draft assembly to actuate said drive shaft during a closing maneuver or an opening maneuver of said switching unit.

According to an embodiment of the present disclosure, each eccentric mechanism is movable, upon actuation by said drive shaft, between a first end-of-run position, at which the movable contact of the corresponding switching pole is in said open position, and a second end-of-run position, at which said movable contact is in said closed position and under a mechanical load forcing it against the fixed contact.

Each eccentric mechanism reaches said first end-of-run position at the end of an opening maneuver of said switching unit and stably maintains said first end-of-run position until a closing maneuver of said switching unit is carried out, even if said eccentric mechanism is no more actuated by said drive shaft.

Each eccentric mechanism reaches said second end-of-run position at the end of a closing maneuver of said switching unit and stably maintains said second end-of-run position until an opening maneuver of said switching unit is carried out, even if said eccentric mechanism is no more actuated by said drive shaft.

According to another embodiment of the present disclosure, the drive assembly comprises a first end-of-run element in a fixed position and a second end-of-run element mechanically coupled to said drive shaft so as rotate solidly with said drive shaft. Said second end-of-run element abuts against said first end-of-run element, when said eccentric mechanisms reach said first end-of-run position or said second end-of-run position.

According to an aspect of the present disclosure, each eccentric mechanism passes, during an opening maneuver or a closing maneuver of said switching apparatus, through a first deadlock position, at which the movable contact of the corresponding switching pole is decoupled from said fixed contact and reaches a point of maximum distance from said fixed contact, and passes through a second deadlock position, at which said movable contact is in said closed position and under a maximum mechanical load forcing it against said fixed contact.

According to an aspect of the present disclosure each eccentric mechanism comprises an eccentric body coupled with the drive shaft so as rotate solidly with said drive shaft. Said eccentric body has an eccentric axis spaced from said rotation axis and a crank axis passing through said rotation axis and said eccentric axis along a reference plane perpendicular to said rotation axis.

Each eccentric mechanism further comprises a lever body operatively coupled with said eccentric body so as to be rotatably movable with respect to said eccentric body. Said lever body is hinged to the pushrod of a switching pole at a hinging axis of said lever body and it has a lever axis passing through said hinging axis and said eccentric axis along a reference plane perpendicular to said rotation axis.

According to an aspect of the present disclosure, the drive assembly of the switching unit comprises a single first eccentric mechanism coupled to the pushrod of a first switching pole and a pair of second eccentric mechanisms coupled in parallel to the pushrod of a second switching pole and spaced one from another along the rotation axis of said drive shaft. Said first eccentric mechanism is arranged in an intermediate position between said second eccentric mechanisms.

According to an aspect of the present disclosure, the drive assembly of the switching unit comprises a pair of first eccentric mechanisms, which are coupled in parallel to the pushrod of a first switching pole and spaced apart one from another along the rotation axis of said drive shaft, and a pair of second eccentric mechanisms, which are coupled in parallel to the pushrod of a second switching pole and spaced apart one from another along the rotation axis of said drive shaft. Said first eccentric mechanisms are arranged in alternate positions with said second eccentric mechanisms along the rotation axis of said drive shaft.

In a further aspect, the present disclosure also relates to a switching apparatus including, for each electric phase, a switching unit, according to the present disclosure.

### BRIEF DESCRIPTION OF DRAWINGS

Further features and advantages of the present disclosure will be more apparent from the description of embodiments of the present disclosure, shown by way of examples in the accompanying drawings.

FIGS. 1-4 are schematic views of a switching unit, according to an embodiment of the present disclosure, in different operation conditions (seen along different section planes).

FIGS. 5-9 are schematic views of the drive assembly of the switching unit of FIGS. 1-4.

FIGS. 10-11 are schematic views of the drive assembly of the switching unit, according to an alternative embodiment of the present disclosure.

FIG. 12 is a schematic view of the switching unit, according to an alternative embodiment of the present disclosure.

FIG. 13 is a schematic view of a switching apparatus including a switching unit, according to the present disclosure, for each electric phase.

FIGS. 14-15 schematically show the operation of the switching unit of the present disclosure.

### DETAILED DESCRIPTION

With reference to the above-mentioned figures, the present disclosure relates to a switching unit 1 for electrical applications, which is particularly adapted for being employed in switching apparatuses (particularly in circuit breakers) intended to be installed in medium voltage electrical systems, for example in medium voltage switchgears, switchboards, or electric grids.

In principle, however, the switching unit 1 can be employed in low voltage electrical systems.

For the purposes of the present disclosure, the term “medium voltage” is referred to voltage levels higher than 1 kV AC and 1.5 kV DC up to some tens of kV, for example up to 72 kV AC and 100 kV DC, while the term “low voltage” is referred to voltage levels lower than 1 kV AC and 1.5 kV DC.

The switching unit 1 comprises a pair of switching poles 1A, 1B electrically connected in series.

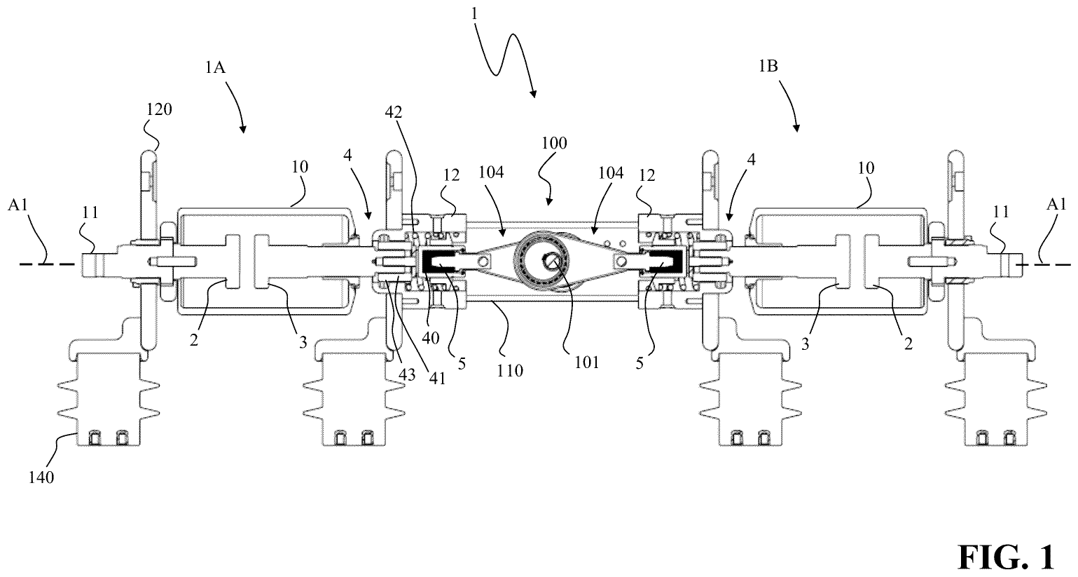

In some embodiments, the switching poles 1A, 1B extend along a common main longitudinal axis according to opposite directions (FIGS. 1-4).

Each switching pole 1A, 1B comprises first and second pole terminals 11, 12.

When the switching unit is installed, the first pole terminal 11 of each switching pole can be electrically connected to a conductor of an electric line.

As the switching poles are electrically connected in series, the second pole terminal 12 of each switching pole is electrically connected to the second pole terminal of the other switching pole. In some embodiments, the switching unit 1 comprises a conductive enclosure electrically connecting the second pole terminals 12 of the switching poles one to another. Other solutions may however be adopted to electrically connect in series the switching poles.

Each switching pole 1A, 1B comprises a vacuum interruption chamber 10 housing, at least partially, a fixed contact 2 and a movable contact 3, which are electrically connected to the first pole terminal 11 and to the second pole terminal 12, respectively.

The vacuum interruption chamber 10 has an outer enclosure defining an internal volume, in which a vacuum atmosphere is obtained. Such an outer enclosure includes airtight apertures through which the above-mentioned fixed contact 2 and the movable contact 3 are inserted.

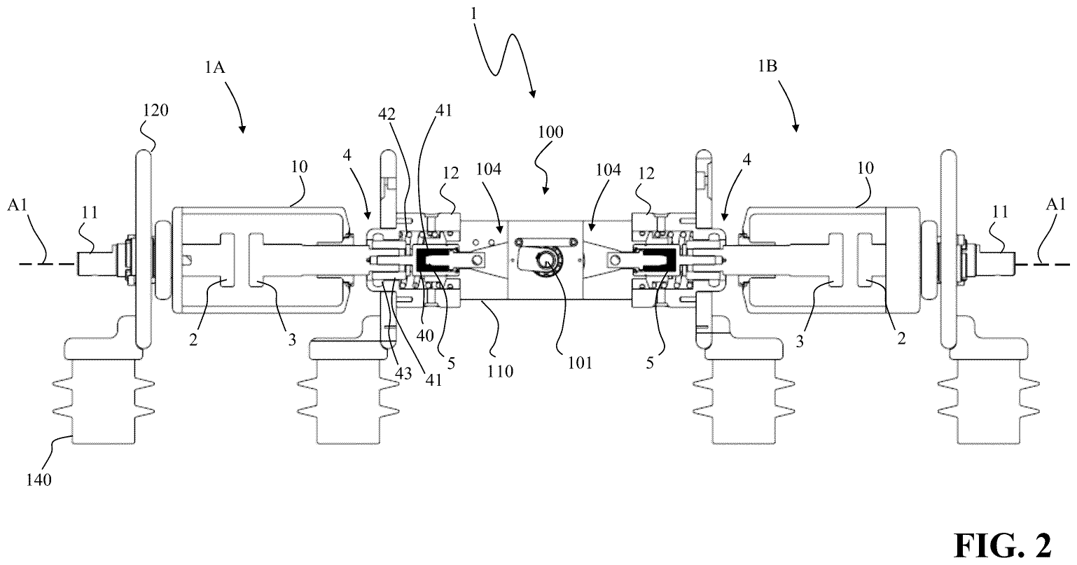

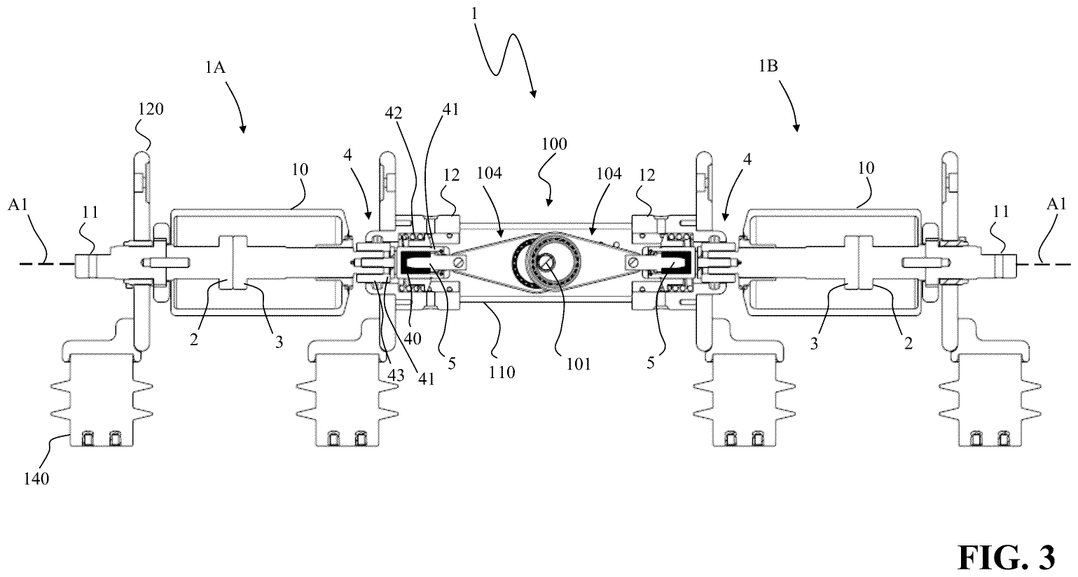

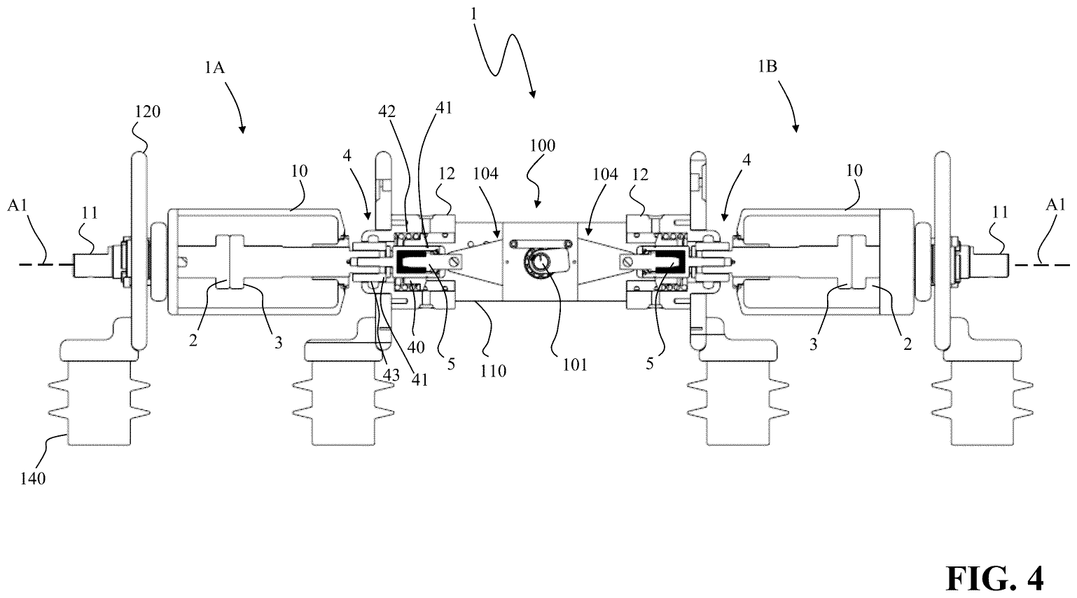

The movable contact 3 of each switching pole can move relative to the vacuum interruption chamber 10 along a translation axis A1 between an open position (FIGS. 1-2), in which it is separated from the fixed contact 2, and a closed position (FIGS. 3-4), in which it is electrically coupled to the fixed contact 2. In some embodiments, translation axis A1 coincides with the main longitudinal axis of the switching pole.

In some embodiments, the movable contact 3 of the switching poles move along a common translation axis A1, which coincides with a common main longitudinal axis of the switching poles.

When it is in the closed position, the movable contact 3 of each switching pole can take a closed condition, in which it is electrically coupled to the fixed contact 2, and a closed and pressed condition, in which it is electrically coupled to the fixed contact 2 under a mechanical load, which forces it against the fixed contact 2.

A transition of the movable contact 3 of each switching pole from an open position to a closed position and a closed and pressed condition forms a closing maneuver of the switching unit. A transition of the movable contact 3 of each switching pole from a closed position and a closed and pressed condition to an open position forms an opening maneuver of the switching unit.

Each switching pole 1A, 1B comprises a motion transmission assembly 4 and a pushrod 5.

The motion transmission assembly 4 is placed outside the vacuum interruption chamber 10 and is operatively coupled to the movable contact 3.

In some embodiments, the motion transmission assembly 4 comprises a motion transmission component 41 electrically and mechanically coupled to the movable contact 3 in such a way to be electrically connected and solidly move with this latter. Such a motion transmission component has a suitable sliding element 43 in electrical contact with the second terminal 12 to form a conductive path between the movable contact 3 and the second terminal 12.

In some embodiments, the motion transmission assembly 4 of each switching pole comprises a contact spring 40 (for example a coil spring or a cup spring) operatively coupled to the motion transmission component 41 and to the pushrod 5.

The contact spring 40 provides the necessary pressing force on the contacts 2, 3 when these latter couple during a closing maneuver of the switching pole. Namely, the contact spring 40 provides a mechanical load forcing the movable contact 3 against the fixed contact 2, when said movable contact is a closed position.

From an operational standpoint, the contact spring 40 is in a discharged or preloaded condition, when the movable contact 3 is in an open position and in a closed position and in a closed condition, and it is compressed, when the movable contact 3 is in a closed position.

In practice, in the position of FIGS. 1-2, the contact spring 40 is in a discharged or preloaded condition, while, in the position of FIGS. 3-4, it is in a loaded condition, thereby providing the required necessary pressing force on the coupled electric contacts 2, 3.

In general, the contact spring 40 acts only during the pressing stroke of the pushrod 5 (namely when the movable contact 3 is in closed position) and provides the required contact pressure on the contact system 2, 3 in the vacuum interruption chamber 10.

In some embodiments, the motion transmission assembly 4 of each switching pole comprises an opening spring 42 operatively coupled to a fixed support and to the motion transmission component 41, which solidly moves with the movable contact 3.

The opening spring 42 is designed to provide a resistance force to the movement of the actuating pushrod 5 and of the movable contact 3 during a closing maneuver of the switching unit and to help the separation of the movable contact 3 from the fixed contact 2 during an opening maneuver of the switching unit.

From an operational standpoint, the opening spring 42 is in a discharged or preloaded condition, when the movable contact 3 is in open position and it is in a loaded condition when the movable contact 3 is in a closed position.

In practice, in the position of FIGS. 1-2 the opening spring 42 is in a discharged or preloaded condition, while it is in a loaded condition in the position of FIGS. 3-4.

In general, the opening spring 42 acts only during a generic transition of the movable contact 3 between a closed position to an open position and provides an efficient system for controlling the mechanical loads and the speeds of the movable contact 3 during a closing maneuver and an opening maneuver of the switching unit.

The pushrod 5 of each switching pole is operatively coupled to the motion transmission assembly 4 and to a drive assembly of the switching unit.

In some embodiments, the pushrod 5 includes a solid elongated body of steel or another material with high mechanical resistance, which is aligned along the translation axis A1 of the movable contact 3.

In some embodiments, the pushrod 5 includes opposite ends operatively coupled to the contact spring 40 and to the drive assembly 100.

In general, the switching poles 1A, 1B of the switching unit can be realized according to solutions of known type, for example those disclosed in EP23189111.0.

Therefore, in the following, they will not describe in further details for the sake of brevity but only with reference to the aspects of interest for the present disclosure.

According to the present disclosure, the switching unit 1 comprises a drive assembly 100 capable of providing mechanical forces to actuate the movable contacts 3 during a closing maneuver or an opening maneuver or of the switching unit.

The drive assembly 100 comprises a drive shaft 101 rotating about a rotation axis A2 during a closing maneuver or an opening maneuver of the switching unit.

In some embodiments, rotation axis A2, is perpendicular to the translation axis A1 of the movable contacts 3 of the switching poles 1A, 1B.

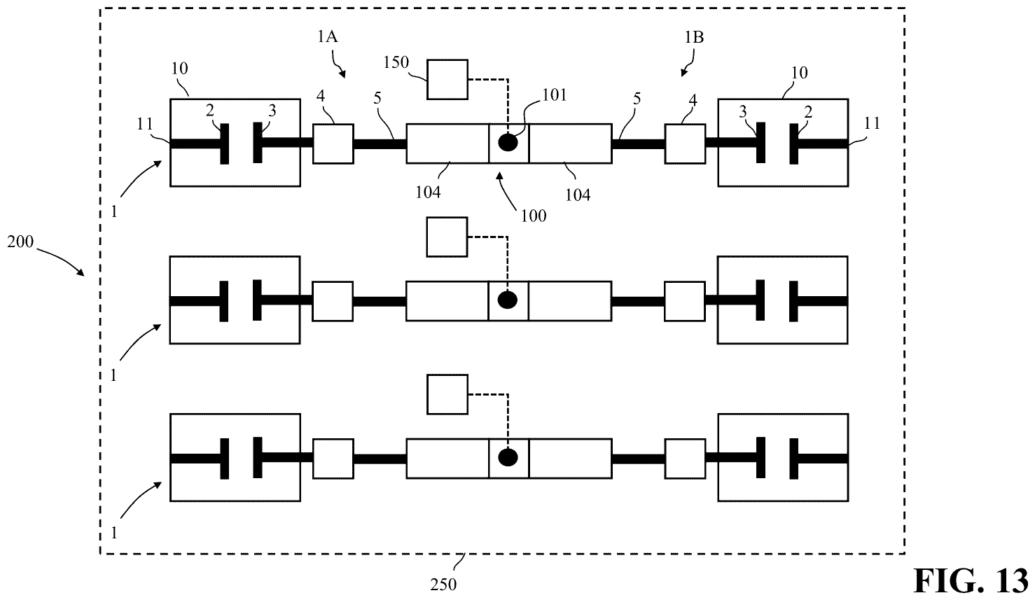

The drive shaft 101 is operatively coupled to an actuating arrangement 150 actuating said drive shaft during a closing maneuver or an opening maneuver of the switching unit (FIG. 13).

The actuating arrangement 150 may include an electric motor (for example a servomotor), an electromagnetic actuator, a hydraulic actuator, a mechanical actuator, or any similar actuators of known type.

The actuating arrangement 150 may be part of the switching unit or not, according to the needs.

The drive assembly 100 comprises a plurality of eccentric mechanisms 104 operatively coupled to the drive shaft 101 and the pushrods 5 of the switching poles 1A, 1B.

Each eccentric mechanism 104 is coupled to the pushrod 5 of a corresponding switching pole, for example through a suitable coupling pin 16.

In principle, the drive assembly 100 can comprise a single first eccentric mechanism coupled to the pushrod 5 of a first switching pole 1A and a single second eccentric mechanism coupled to the pushrod 5 of a second switching pole 1B.

According to some embodiments of the present disclosure, the eccentric mechanisms 104 of the drive assembly are arranged according to symmetrical configurations along the rotation axis A2 of the drive shaft 101 in such a way to ensure that the pushrods 5 of the switching poles 1A, 1B are suitably aligned along a common main longitudinal axis A1 of the switching poles.

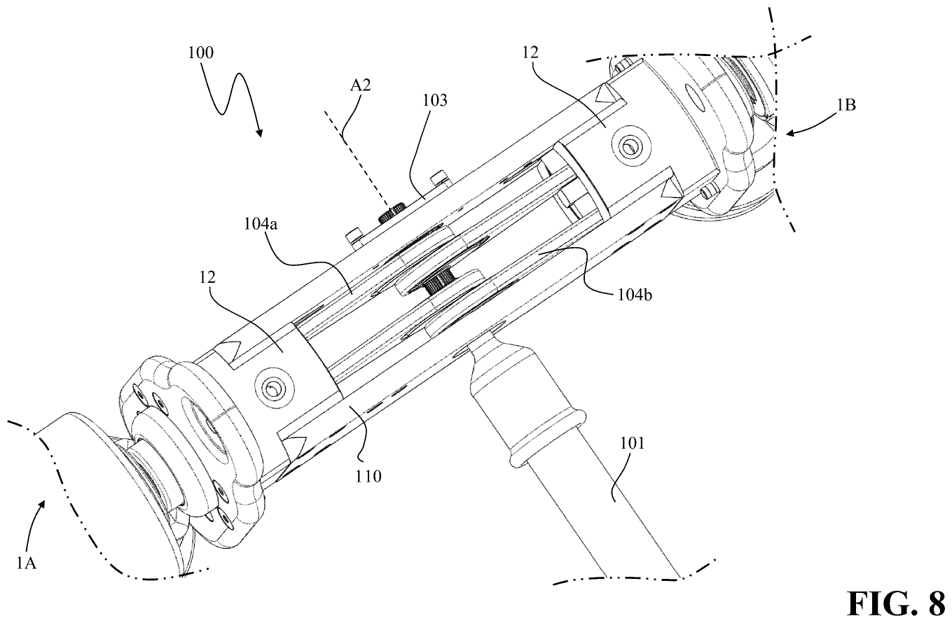

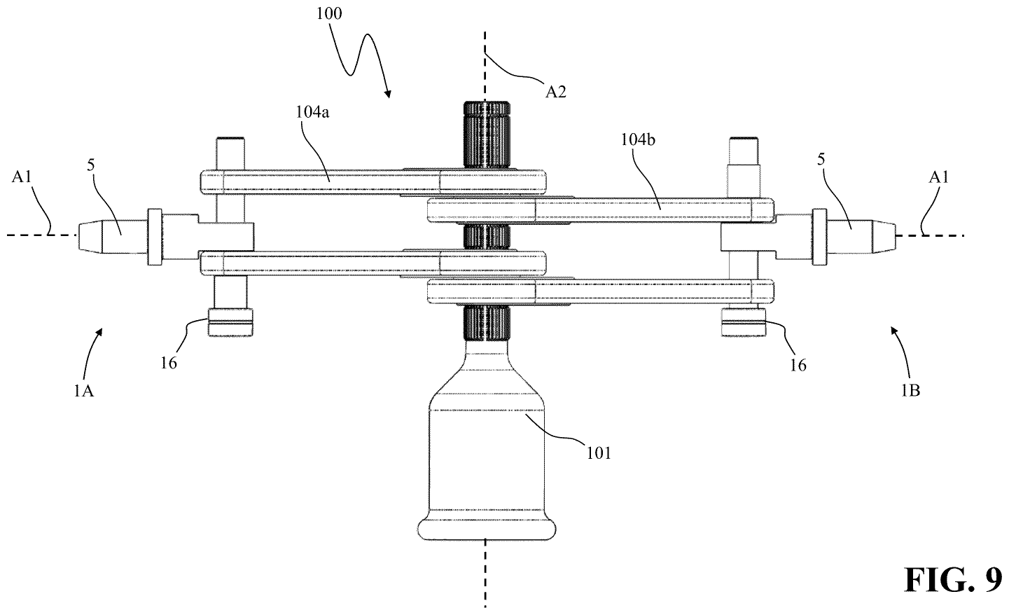

According to some embodiments of the present disclosure (FIGS. 8-9), the drive assembly 100 comprises a pair of first eccentric mechanisms 104a coupled to the pushrod 5 of a first switching pole 1A, which are arranged in parallel and spaced one from another along the rotation axis A2 of the drive shaft 101, and a pair of second eccentric mechanisms 104b coupled to the pushrod 5 of a second switching pole 1B, which are arranged in parallel and spaced one from another along the rotation axis A2 of the drive shaft 101.

The first eccentric mechanisms 104a are conveniently arranged in alternate positions with the second eccentric mechanisms 104b along the rotation axis A2 of said drive shaft 101.

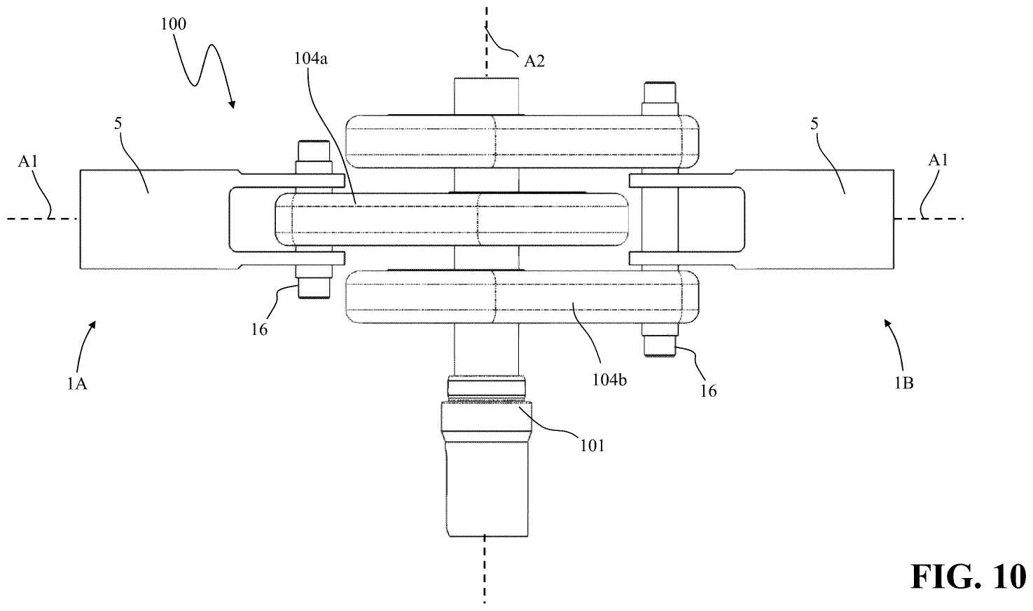

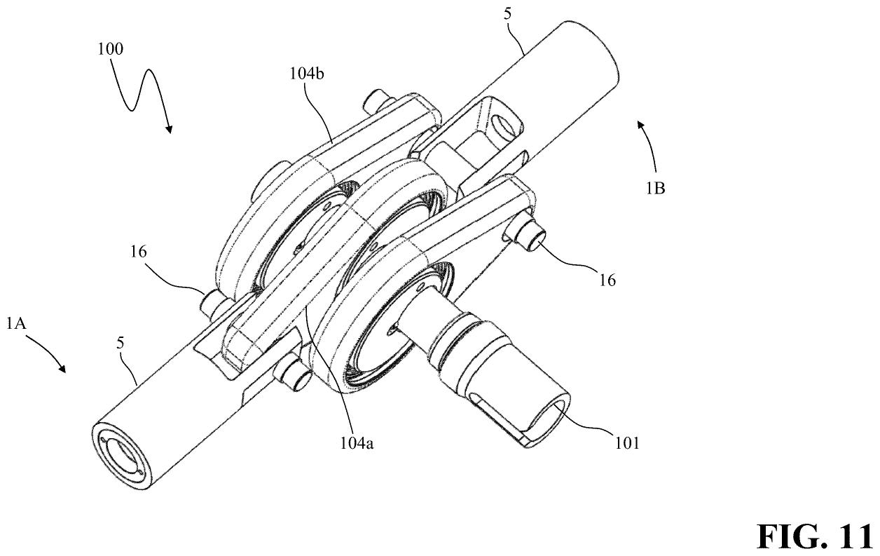

According to other embodiments of the present disclosure (FIGS. 10-11), the drive assembly 100 comprises a single first eccentric mechanism 104a coupled to the pushrod 5 of a first switching pole 1A and a pair of second eccentric mechanisms 104b coupled to the pushrod 5 of a second switching pole 1B, which are arranged in parallel and spaced one from another along the rotation axis A2 of the drive shaft 101. The first eccentric mechanism 104a is conveniently arranged in an intermediate position between the second eccentric mechanisms 104b (along the rotation axis A2).

In general, each eccentric mechanism 104 is actuated by rotational mechanical forces provided by the drive shaft 101 and provides, in turn, corresponding translational mechanical forces to the pushrod 5 of a corresponding switching pole 1A, 1B to actuate the movable contact 3 during a closing maneuver or an opening maneuver of the switching unit.

During an opening maneuver or a closing maneuver of the switching apparatus, each eccentric mechanism 104 is movable between a first end-of-run position P1 (FIGS. 1-2, 14a), at which the corresponding movable contact 3 is the aforesaid open position, and a second end-of-run position P2 (FIGS. 3-4, 15c), at which the corresponding movable contact 3 is the aforesaid closed position and under a mechanical load forcing it against the fixed contact.

Each eccentric mechanism 104 reaches its first end-of-run position P1 at the end of an opening maneuver of the switching unit and stably maintains said first end-of-run position until a closing maneuver of the switching apparatus is carried out. Each eccentric mechanism 104 can stably maintain the first end-of-run position P1 even if it is no more actuated by the drive shaft 101 (and the actuator 102).

Each eccentric mechanism 104 reaches its second end-of-run position P2 at the end of a closing maneuver of the switching unit and stably maintains said second end-of-run position until an opening maneuver of the switching apparatus is carried out. Each eccentric mechanism 104 can stably maintain the second end-of-run position P2 even if it is no more actuated by the drive shaft 101 (and the actuator 102).

In some embodiments, the drive assembly 100 comprises a first end-of-run element 103 in a fixed position

and a second end-of-run element 105 mechanically coupled with the drive shaft 101 so as rotate solidly with said drive shaft.

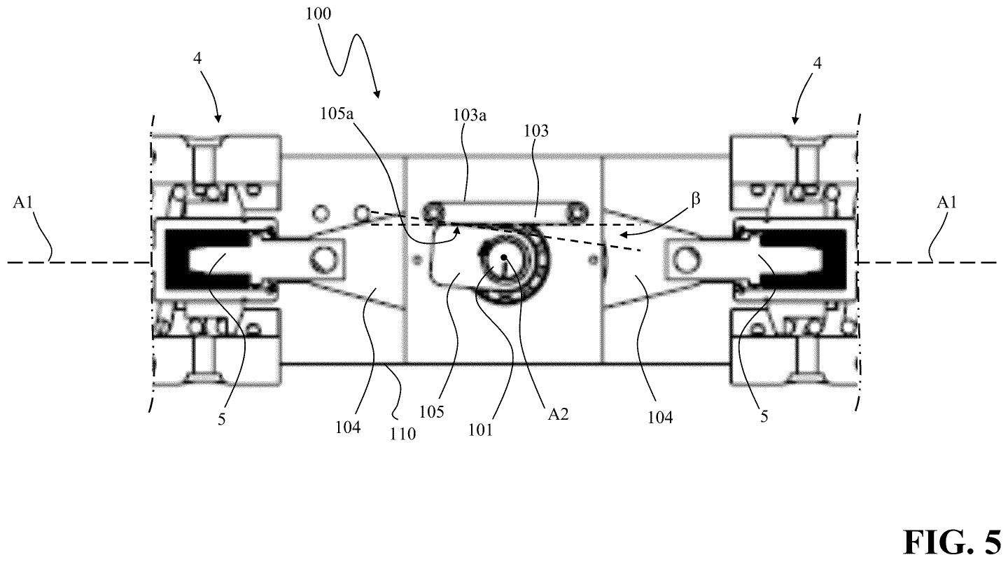

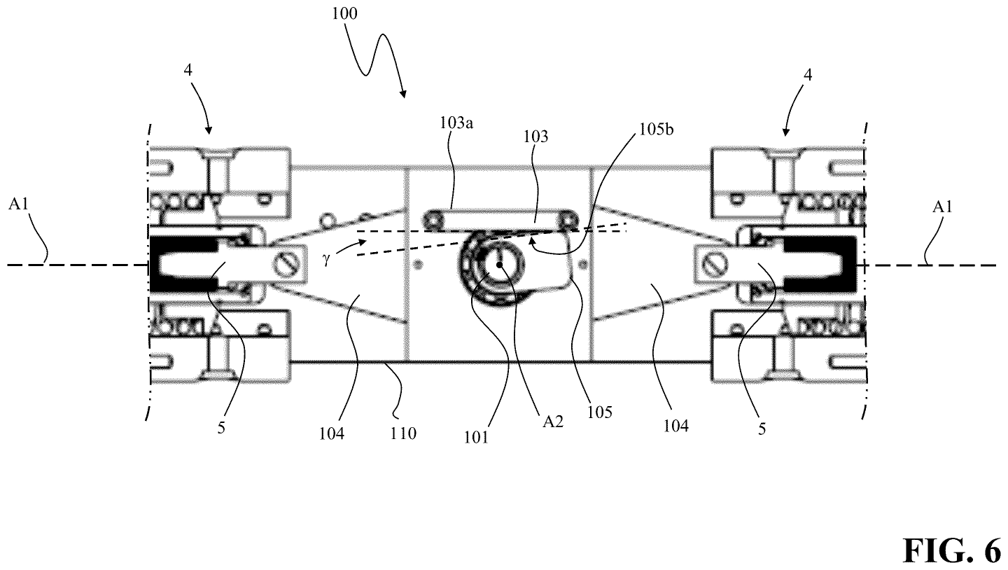

As shown in FIGS. 5-6, the first end-of-run element 103 may be formed by a plate fixed to the conductive enclosure 110 of the switching unit while the second end-of-run element 105 may be formed by a plate joined to the drive shaft 101.

The second end-of-run element 105 rotates together with the drive shaft 101 during a closing maneuver or an opening maneuver of the switching unit.

The second end-of-run element 105 abuts against the first end-of-run element 103, when the eccentric mechanisms 104 of the drive assembly reach the first end-of-run position P1 or the second end-of-run position P2 during a closing maneuver or an opening maneuver of the switching unit.

In some embodiments, the second end-of-run element 105 comprises a first abutment surface 105a abutting against a stop surface 103a of the first end-of-run element 103, when the eccentric mechanisms 104 of the drive assembly reach the first end-of-run position P1 (FIG. 5).

In some embodiments, when the first abutment surface 105a abuts against the stop surface 103a, the first abutment surface 105a and the stop surface 103a define a first angle β>0° on a reference plane perpendicular to the rotation axis A2 of the drive shaft 101. Such an angle can be tuned to define the above-mentioned first end-of-run position P1 of the eccentric mechanisms 104 at the end of an opening maneuver of the switching unit (FIG. 5).

In some embodiments, the second end-of-run element 105 comprises a second abutment surface 105b abutting against the stop surface 103a of the first end-of-run element 103, when the eccentric mechanisms 104 of the drive assembly reach the second end-of-run position P2 (FIG. 6).

In some embodiments, when the second abutment surface 105b abuts against the stop surface 103a, the second abutment surface 105b and the stop surface 103a define a second angle γ>0° on a reference plane perpendicular to the rotation axis A2 of the drive shaft 101. Such an angle can be tuned to define the above-mentioned second end-of-run position P2 of the eccentric mechanisms 104 at the end of a closing maneuver of the switching unit (FIG. 5).

The arrangement of the end-of-run elements 103, 105 is particularly advantageous, as it ensures that the first end-of-run position P1 or the second end-of-run position P2 are stably maintained by the eccentric mechanisms 104 at the end of a closing maneuver or an opening maneuver of the switching unit.

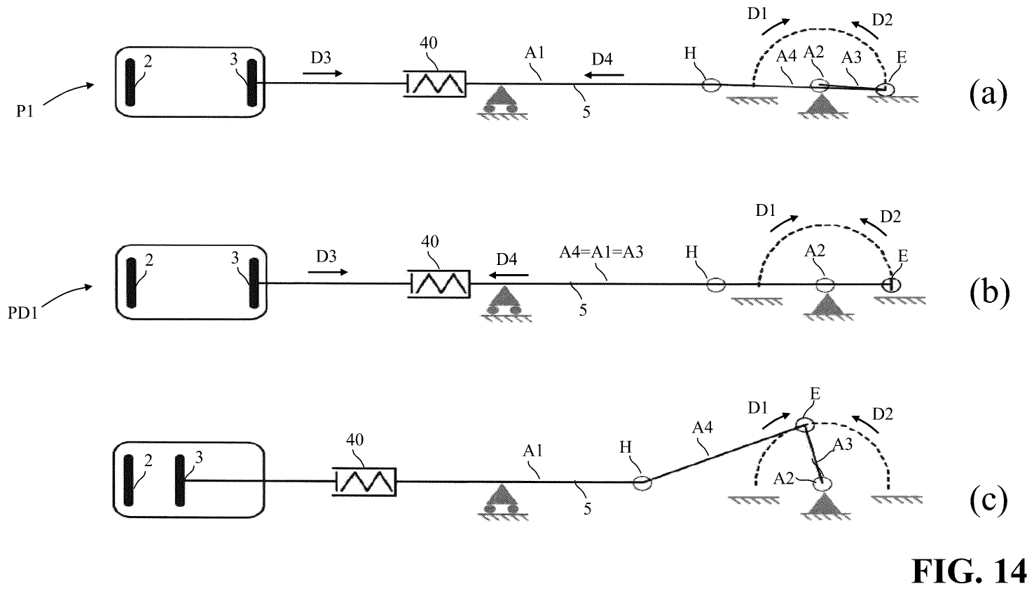

In some embodiments, during an opening maneuver or a closing maneuver of the switching apparatus, each eccentric mechanism 104 passes through a first deadlock position PD1, at which the movable contact 3 of each switching pole is decoupled from the fixed contact 2 and reaches a point of maximum distance from said fixed contact (FIG. 14b).

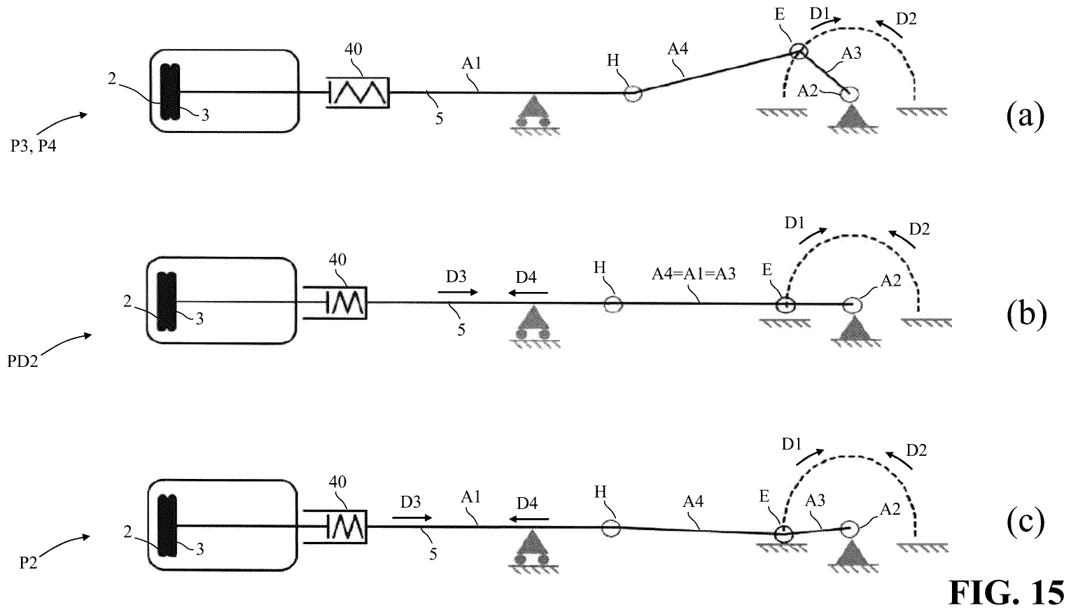

In some embodiments, during an opening maneuver or a closing maneuver of the switching apparatus, each eccentric mechanism 104 passes through a second deadlock position PD2, at which the movable contact 3 of each switching pole is coupled to the fixed contact 2, namely is in the above-mentioned closed position and under a maximum mechanical load forcing it against said fixed contact (FIG. 15b). In this situation, the contact spring 40 of motion transmission assembly 4 of each switching pole stores a maximum amount of elastic energy.

In some embodiments, during a closing maneuver of the switching unit, each eccentric mechanism 104 leaves the first end-of-run position P1, at which the movable contact 3 of each switching pole is in the aforesaid open position and is spaced from the fixed contact 2 of a distance shorter than the maximum distance reached by the movable contact 3 when the eccentric mechanism 104 is in the above-mentioned first deadlock position PD1 (FIG. 14a). During the a closing maneuver of the switching unit, each eccentric mechanism also passes through the first deadlock position PD1 (FIG. 14b) and passes through an intermediate position, at which the movable contact 3 of each switching pole couples with the fixed contact 2, thereby being in a closed position and in a closed condition (FIG. 15a). Additionally, during a closing maneuver of the switching unit, each eccentric mechanism passes through the second deadlock position PD2 (FIG. 15b) and reaches the second end-of-run position P2, at which the movable contact 3 of each switching pole is in the aforesaid closed position and under a mechanical load lower than the maximum mechanical load, to which the movable contact 3 is subject when the eccentric mechanism 104 is in the above-mentioned second deadlock position PD2 (FIG. 15c). In this situation, the contact spring 40 of motion transmission assembly 4 of each switching pole stores an amount of elastic energy maximum lower than the maximum amount stored when the eccentric mechanism 104 is in the above-mentioned second deadlock position PD2.

In some embodiments, during a closing maneuver of the switching unit, each eccentric mechanism 104 leaves the second end-of-run position P2, at which the movable contact 3 of each switching pole is in the aforesaid closed position and under a mechanical load lower than the maximum mechanical load, to which the movable contact 3 is subject when the eccentric mechanism 104 is in the above-mentioned second deadlock position PD2 (FIG. 15c). In this situation, the contact spring 40 of motion transmission assembly 4 of each switching pole stores an amount of elastic energy maximum lower than the maximum amount stored when the eccentric mechanism 104 is in the above-mentioned second deadlock position PD2. During a closing maneuver of the switching unit, each eccentric mechanism also passes through the second deadlock position PD2 (FIG. 15b) and passes through an intermediate position, at which the movable contact 3 of each switching pole decouples from the fixed contact 2 (FIG. 15a). Furthermore, during a closing maneuver of the switching unit, each eccentric mechanism passes through the first deadlock position PD1 (FIG. 14b) and reaches the first end-of-run position P1, at which the movable contact 3 of each switching pole is in the aforesaid open position and is spaced from the fixed contact 2 of a distance shorter than the maximum distance reached by the movable contact 3 when the eccentric mechanism 104 is in the above-mentioned first deadlock position PD1 (FIG. 14a).

The structure of the eccentric mechanisms 104 of the drive assembly 100, according to the embodiments shown in the cited figures, is now described in more details.

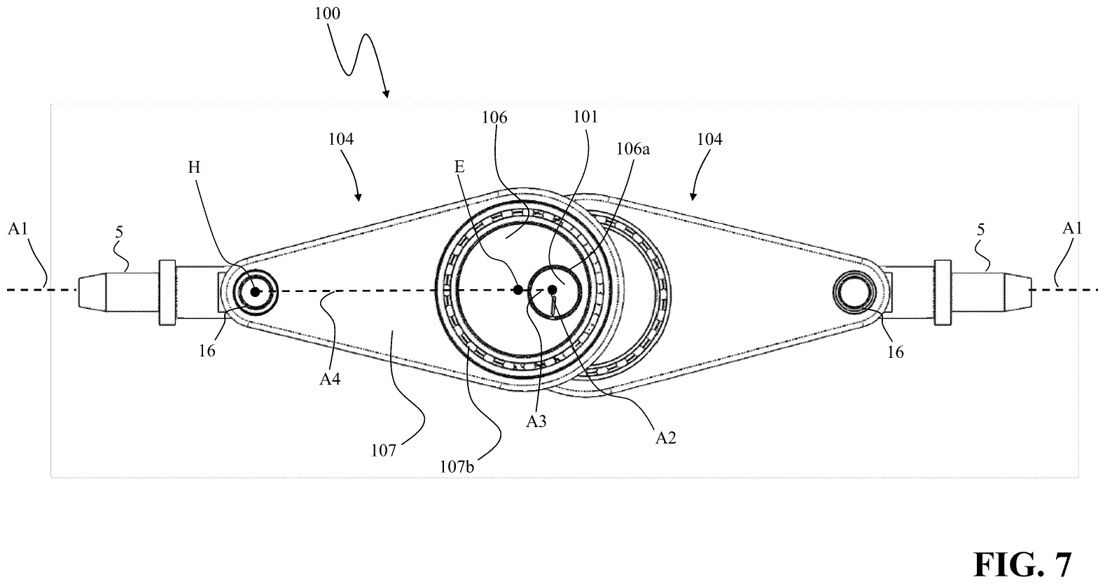

In some embodiments, each eccentric mechanism 104 comprises an eccentric body 106 coupled with the drive shaft 101 so as rotate solidly with this latter (FIG. 7).

The eccentric body 106 has an eccentric axis E passing through a center of symmetry of said eccentric body. The eccentric axis E is distinct and spaced from the rotation axis A2 of the drive shaft 101 and extends in parallel to said rotation axis.

During a closing maneuver or an opening maneuver of the switching unit, the eccentric body 106 and its eccentric axis E rotate together with the drive shaft 101 about the rotation axis A2.

Along a reference plane perpendicular to the rotation axis A2 (and to the eccentric axis E), the eccentric body 106 has a crank axis A3, which passes through the rotation axis A2 and the eccentric axis E.

In some embodiments, the eccentric body 106 comprises a first shaped cavity 106a coaxial with the rotation axis A2 of the drive shaft 101. The drive shaft 101 passes through the cavity 106a and, at such a cavity, it is mechanically coupled to the eccentric body 106 by means of a coupling key or other coupling means of similar type.

In some embodiments, each eccentric mechanism 104 comprises a lever body 107 operatively coupled to the eccentric body 106 so as to be rotatably movable with respect to said eccentric body.

The lever body 107 is rotatably coupled with the pushrod 5 of a corresponding switching pole 1A, 1B at a hinging axis H parallel to the rotation axis A2 of the drive shaft 101 and the eccentric axis E of the eccentric body 106 (FIG. 7).

Along a reference plane perpendicular to the rotation axis A2 (and to the eccentric axis E and the hinging axis H), the lever body 107 has a lever axis A4 passing through to the hinging axis H and the eccentric axis E.

The lever axis A4 of the lever body 107 is aligned with the crank axis A3 of the eccentric body 106 and with the translation axis A1 of the movable contact 3, when an eccentric mechanism 104 is the deadlock positions PD1, PD2 during a closing maneuver or an opening maneuver of the switching unit.

When an eccentric mechanism 106 reaches the first end-of-run position P1 or the second end-of-run position P2, the crank axis A3 of the eccentric body 106 and the lever axis A4 of the lever body 107 form an angle having an absolute value of lower than or equal to 5°, along a reference plane perpendicular to the rotation axis A2 of the drive shaft 101.

As it will be better illustrated in the following, this feature, which is obtained respectively thanks to an over-rotation of eccentric mechanism 104 beyond the first deadlock position PD1 or the second deadlock position PD2, contributes to ensure that the first end-of-run position P1 or the second end-of-run position P2 are stably maintained at the end of a closing maneuver or an opening maneuver of the switching unit.

It is evidenced that, when the eccentric mechanism 104 is in the first end-of-run position P1, the over-rotation of a small angle implies a small reduction of the distance between the movable contact 3 and the fixed contact 2 compared to the maximum distance reached when the eccentric mechanism 104 is in the first deadlock position PD1 (FIG. 14a).

It is also evidenced that, when the eccentric mechanism 104 is in the second end-of-run position P2, the over-rotation of a small angle implies a small reduction of mechanical load forcing the movable contact 3 against the fixed contact 2 compared to the maximum mechanical load, to which the movable contact 3 is subject when the eccentric mechanism 104 is in the above-mentioned second deadlock position PD2 (FIG. 15c).

In some embodiments, the lever body 107 comprises a second shaped cavity 107a coaxial with the eccentric body 106, in particular with the eccentric axis E of this latter (FIG. 7).

In some embodiments, the second cavity 107a is a pass-through cavity and the eccentric body 106 is at least partially inserted within said cavity for mechanical coupling with the lever 107.

In some embodiments, the lever body 107 comprises a bearing coupling arrangement 107b (for example of the ball bearing, needle bearing or roller bearing type) in the second cavity 107 for mechanical coupling with the eccentric body 106. In this way, when the eccentric body 106 rotates together with the drive shaft 101, the connecting lever body 107 can swing with respect to the eccentric body 106 (in a same relative direction) about the eccentric axis E of this latter.

As explained above, the lever body 107 of each eccentric mechanism 104 is rotatably coupled with the pushrod 5 of a corresponding switching pole 1A, 1B at a hinging axis H.

In some embodiments, when multiple eccentric mechanisms 104 are operatively coupled to a same pushrod 5 (FIGS. 8-11) of a switching pole, these eccentric mechanisms have their lever bodies 107 arranged at opposite sides of the pushrod 5 and coupled to the pushrod 5 through a common coupling pin 16 extending along a common hinging axis H.

In some embodiments, when a single eccentric mechanism 104a is operatively coupled to the pushrod 5 of a switching pole (FIGS. 10-11), such an eccentric mechanism has its lever body 107 aligned with the pushrod 5 (along the translation axis A1) and coupled to the pushrod 5 through a coupling pin 16 extending along the hinging axis H.

As explained above, the drive assembly 100 comprises eccentric mechanisms 106 to mechanically coupled a rotating drive shaft 101 to the pushrods 5 of the switching poles.

This solution allows reducing drastically the intensity of lateral force components acting on the pushrods 5 during a closing maneuver or opening maneuver of the switching unit in comparison to traditional solutions of the state of the art. This is basically due to the circumstance that the drive components (the lever body 107 of each eccentric mechanism) hinged with the pushrods 5 of the switching poles rotate about the respective hinging axes H with a relatively small rotation angle range (about) 10° relative to the translation axis A1 (along a reference plane perpendicular to the rotation axis A2 of the drive shaft) to drive said pushrods during a closing maneuver or an opening maneuver of the switching unit.

The operation of the switching unit 1 is now explained in detail with reference to FIGS. 14, 15 schematically showing the behavior of each switching pole 1A, 1B in different operating conditions.

When the switching unit 1 is in an open state, the movable contact 3 of each switching pole is in the open position and is spaced from the fixed contact 2 of a distance slightly shorter (few hundredths of mm) than the maximum distance (maximum stroke) that can be reached by the movable contact (FIG. 14a).

The contact spring 40 of each switching pole is not compressed (with respect to its biasing state).

Each eccentric mechanism 104 of the drive assembly is in the first end-of-run position P1.

The second end-of-run element 105 of the drive assembly abuts against the first end-of-run element 103 at its first abutment surface 105a (FIG. 5).

The eccentric axis A3 of the eccentric body 107 and the lever axis A4 of the lever body 107 of each eccentric mechanism 104 form an angle of few degrees (for example lower, or equal to) 5°.

Each eccentric mechanism 104 is capable of stably maintaining the first end-of-run position P1 until a closing maneuver of the switching apparatus is carried out, even if it is not actuated by the drive shaft 101. The actuator 150 can thus be deactivated (switched off).

The abutment of the second end-of-run element 105 against the first end-of-run element 103 prevents any further movement of the eccentric mechanism 104 in the rotation direction D1.

On the other hand, as the eccentric axis A3 and the connecting rod axis A4 are not mutually aligned, any force directed to move the movable contact 3 towards the fixed contact 2 (such as the vacuum force caused by the pressure difference between the inside and the outside of the vacuum chamber 10) has a lateral component opposing to a movement of the eccentric mechanism in the rotation direction D2.

Each eccentric mechanism 104 maintains the first end-of-run position P1 until the actuator 150 is activated and the drive shaft 101 provides rotational actuation forces to carry out a closing maneuver.

In order to carry out a closing maneuver, the actuating arrangement 150 is activated and the drive 101 shaft is rotated according to the rotation direction D2 (FIG. 14b).

The second end-of-run element 105 leaves its in abutment position against the first end-of-run element 103 and rotates according to the same rotation direction D2.

The eccentric body 106 (eccentric axis E) of each eccentric mechanism rotates according to the same direction as any force opposing the movement of the eccentric mechanism in the rotation direction D2 is overcome by the rotational actuation forces exerted by the drive shaft 101.

Each eccentric mechanism 104 thus moves towards the first deadlock position PD1 (FIG. 14b). During the movement of each eccentric mechanism 104 between the first end-of-run position P1 and the first deadlock position PD1, the pushrod 5 of the corresponding switching pole slightly moves according to the translation direction D3 (along the translation axis A1) thereby further separating (some hundredths of mm) the movable contact 3 from the fixed contact 2 (FIG. 14b).

When it reaches the first deadlock position PD1, each eccentric mechanism 106 has the eccentric axis A3 and the lever axis A4 aligned or parallel to the translation axis A1. The movable contact 3 of the corresponding switching pole reaches its maximum distance from the fixed contact 2.

As it is moved by the drive shaft 101, each eccentric mechanism 106 passes over the first deadlock position PD1 and moves towards the second deadlock position PD2. At this stage, the pushrod 5 moves according to the translation direction D4, thereby moving the movable contact 4 towards the fixed contact 3 (along the translation axis A1) (FIG. 14c).

While moving between the first deadlock PD1 and the second deadlock position PD2, the eccentric mechanism 6 reaches an intermediate position P3, at which the movable contact 3 of the corresponding switching pole couples with the fixed contact 2, thereby reaching a closed position (FIG. 15a).

During the movement of the eccentric mechanism 106 between the first end-of-run position P1 and the intermediate position P3, since the movable contact 3 is not coupled with the fixed contact 2, the contact spring 40 of the corresponding switching pole is not compressed (with respect to its biasing state) and it moves solidly with the pushrod 4 and the movable contact 3.

As it is moved by the drive shaft 101, each eccentric mechanism 106 passes over the intermediate position P3 and continues to move towards the second deadlock position PD2.

During the movement of the eccentric mechanism 106 between the intermediate position P3 and the second deadlock position PD2, the pushrod 5 of the corresponding switching pole moves (according to the direction D4) relatively to the movable contact 3 and the contact spring 60 is subject to compression. The movable contact 3 is subject to a mechanical load pushing it against the fixed contact 2.

When it reaches the second deadlock position PD2, each eccentric mechanism 106 has the eccentric axis A3 and the lever axis A4 aligned or parallel to the translation axis A1. The contact spring 40 of the corresponding switching pole reaches its maximum compression (FIG. 15b). The movable contact 3 remains in a closed position and it is subject to a maximum mechanical load pushing it against the fixed contact 2.

As it is moved by the drive shaft 101, each eccentric mechanism 106 passes over the second deadlock position PD2 and moves towards the second end-of-run position P2 (over-rotation with respect to the second deadlock position PD2).

During the movement of the eccentric mechanism 6 between the second deadlock position PD2 and the second end-of-run position P2, the pushrod 5 of the corresponding switching pole slightly moves (some hundredths of mm) according to the direction D3 relatively the movable contact 3. The contact spring 40 releases some elastic energy with respect to the maximum compression state reached with the eccentric mechanism 6 was in the second deadlock position PD2. The movable contact 3 remains in a closed state and it is subject to a mechanical load pushing it against the fixed contact 2, which is lower than the above-mentioned maximum mechanical load.

The closing maneuver ends when each eccentric mechanism 6 reaches the second end-of-run position P2 (FIG. 15c) and the second end-of-run element 105 of the drive assembly abuts against the first end-of-run element 103 at its second abutment surface 105b (FIG. 6).

When the switching unit 1 is in a closed state, the movable contact 3 of each switching pole is in the closed position and in a closed and pressed condition.

The contact spring 40 of each switching pole stores a lower amount of elastic energy compared to the maximum compression state reached with each eccentric mechanism 106 was in the second deadlock position PD2. The movable contact 3 of each switching pole is thus subject to a mechanical load pushing it against the fixed contact 2, which is lower than the above-mentioned maximum mechanical load.

Each eccentric mechanism 104 of the drive assembly is in the second end-of-run position P2.

The second end-of-run element 105 of the drive assembly abuts against the first end-of-run element 103 at its second abutment surface 105b (FIG. 6).

The eccentric axis A3 of the eccentric body 107 and the lever axis A4 of the lever body 107 of each eccentric mechanism 104 form an angle of few degrees (for example lower, or equal to) 5°.

Each eccentric mechanism 104 is capable of stably maintaining the second end-of-run position P2 until an opening maneuver of the switching apparatus is carried out, even if it is not actuated by the drive shaft 101. The actuator 150 can thus be deactivated (switched off).

The abutment of the second end-of-run element 105 against the first end-of-run element 103 prevents any further movement of the eccentric mechanism 104 in the rotation direction D2.

On the other hand, as the eccentric axis A3 and the connecting rod axis A4 are not mutually aligned, any force directed to move the movable contact 3 towards the fixed contact 2 (for example due to vibrations or the weight force of the pushrod 5) has a lateral component opposing to a movement of the eccentric mechanism in the rotation direction D1.

Each eccentric mechanism 104 is thus maintained in the second end-of-run position P2 until the actuator 150 is activated and the drive shaft 101 provides rotational actuation forces to carry out an opening maneuver.

In order to carry out an opening maneuver, the actuating arrangement 150 is activated and the drive 101 shaft is rotated according to the rotation direction D1 (FIG. 15c).

The second end-of-run element 105 leaves its in abutment position against the first end-of-run element 103 and rotates according to the same rotation direction D1.

The eccentric body 106 (eccentric axis E) of each eccentric mechanism rotates according to the same direction as any force opposing the movement of the eccentric mechanism in the rotation direction D1 is overcome by the rotational actuation forces exerted by the drive shaft 101.

Each eccentric mechanism 104 thus moves towards the second deadlock position PD1.

During the movement of each eccentric mechanism 104 between the second end-of-run position P2 and the second deadlock position PD2, the pushrod 5 of the corresponding switching pole slightly moves according to the translation direction D4 (along the translation axis A1) thereby further moving (some hundredths of mm) the movable contact 3 towards the fixed contact 2 (FIG. 15b).

When it reaches the second deadlock position PD2, each eccentric mechanism 106 has the eccentric axis A3 and the lever axis A4 aligned or parallel to the translation axis A1.

The contact spring 40 of the corresponding switching pole reaches its maximum compression (FIG. 15b).

The movable contact 3 remains in a closed position and in a closed and pressed condition and it is subject to a maximum mechanical load pushing it against the fixed contact 2.

As it is moved by the drive shaft 101, each eccentric mechanism 106 passes over the second deadlock position PD2 and moves towards the first deadlock position PD1.

At this stage, the pushrod 5 of the corresponding switching pole moves relative to the movable contact 3 (according to the translation direction D3) along the translation axis A1.

The contact spring 40 progressively releases elastic energy compared to the maximum compression state reached with each eccentric mechanism 106 in the second deadlock position PD2.

The movable contact 3 remains in a closed position and it is subject to a progressively decreasing mechanical load pushing it against the fixed contact 2.

While moving between the second deadlock PD2 and the first deadlock position PD1, each eccentric mechanism 106 reaches an intermediate position P4 (which in some embodiments coincides with the intermediate position P3), at which the movable contact 3 of the corresponding switching pole is still coupled to the fixed contact 2 (closed position).

The contact spring 40 of the corresponding switching pole is not compressed (with respect to its biasing state) and the movable contact 3 is no more subject to a mechanical load pushing it against the fixed contact 2 (FIG. 15a).

The pushrod 5 of the corresponding switching pole starts moving solidly with the movable contact 3 (and the contact spring 40) along the translation direction D3. The movable contact 3 starts being dragged away from the fixed contact 2, thereby decoupling from this latter.

As it is moved by the drive shaft 101, each eccentric mechanism 106 passes over the intermediate position P4 and continues to move towards the first deadlock position PD1. At this stage, the pushrod 5 moves according to the translation direction D3, thereby moving the movable contact 3 away from the fixed contact 2 (along the translation axis A1) (FIG. 14c).

When it reaches the first deadlock position PD1, each eccentric mechanism 106 has the eccentric axis A3 and the lever axis A4 aligned or parallel to the translation axis A1. The movable contact 3 of the corresponding switching pole reaches its maximum distance from the fixed contact 2 (FIG. 14b).

As it is moved by the drive shaft 101, each eccentric mechanism 106 passes over the first deadlock position PD1 and moves towards the first end-of-run position P1 (over-rotation with respect to the first deadlock position PD1).

During the movement of the eccentric mechanism 6 between the first deadlock position PD1 and the first end-of-run position P1, the pushrod 5 of the corresponding switching pole slightly moves according to the translation direction D4 (along the translation axis A1) thereby further moving (some hundredths of mm) the movable contact 3 towards the fixed contact 2 (FIG. 14a).

The opening maneuver ends when each eccentric mechanism 106 reaches the first end-of-run position P1 (FIG. 14a) and the second end-of-run element 105 of the drive assembly abuts against the first end-of-run element 103 at its first abutment surface 105a (FIG. 5). The movable contact 3 of the corresponding switching pole is in the open position.

In some embodiments, the switching unit 1 comprises, for each switching pole, an insulating case 120 (partially shown in FIGS. 1-4, 12) accommodating and supporting the internal components of the switching pole.

The switching unit comprises fixing arrangements to fix the switching poles 1A. 1B to an outer supporting structure (not shown).

In some embodiments, said fixing arrangements comprise a plurality of insulating supporting members 140 coupling the insulating case 120 of each switching pole to the outer supporting structure.

In the embodiment shown in FIGS. 1-4, similarly to traditional solutions of the state of the art, said fixing arrangements comprise a pair of insulating supporting members 140 for each switching pole (approximately positioned at the first terminal 11 of each switching pole and the motion transmission assembly 4 of each switching pole).

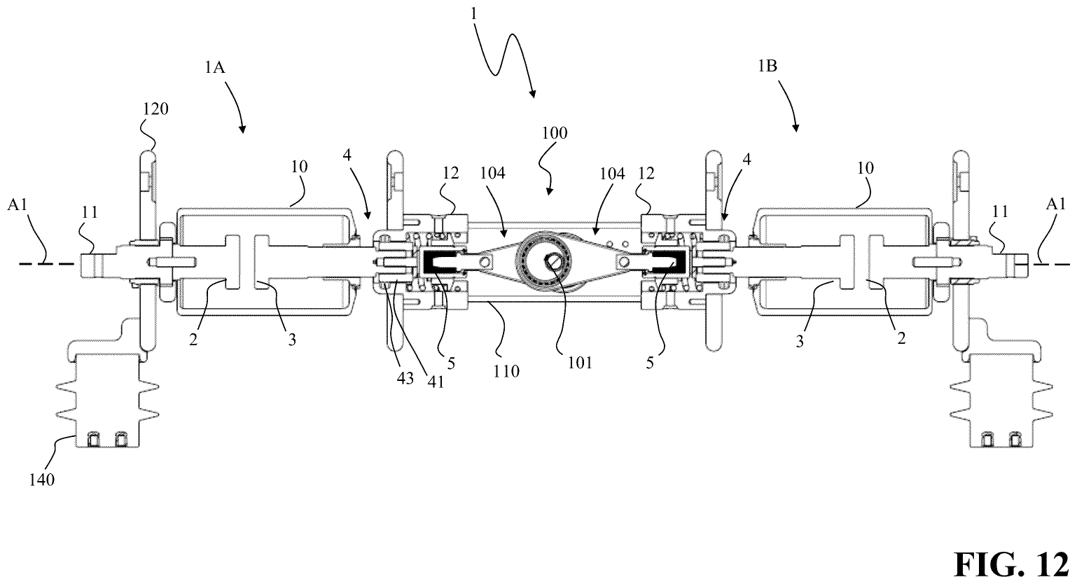

In some embodiments of FIG. 12, however, said fixing arrangements comprise a single insulating supporting member 140 for each switching pole (approximately positioned at the first terminal 11 of each switching pole). This is made possible by the circumstance that the switching unit is less subject to vibrations and backslashes compared to traditional solutions of the state of the art as the innovative drive assembly 100 allows reducing lateral forces exerted on the pushrods 5 of the switching poles during a closing maneuver or opening maneuver.

In some embodiments, the switching unit 1 comprises a conductive casing 110 to enclose the components of the drive assembly 100. As mentioned above, such a conductive casing is conveniently exploited to electrically connect the second terminals 12 of the switching poles 1A, 1B in such a way that these latter are electrically connected in series.

In a further aspect the present disclosure also relates to a switching apparatus comprising one or more switching units according to the present disclosure.

FIG. 13 shows, as an example, a medium voltage switching apparatus 200 including a switching unit 1, according to the present disclosure, for each electric phase.

In FIG. 13, only the relevant components of the switching poles 1A, 1B of the switching unit are represented while the other details are not shown for simplicity purposes.

The switching apparatus 200 comprises a gas tight enclosure 250 which houses the switching units 1 according to the present disclosure.

The drive assemblies 100 of the switching units are operated in a synchronized manner and are, in some embodiments, accommodated within the enclosure 250.

The actuating arrangements 150 of the switching units can be accommodated in the enclosure 250 (as shown in FIG. 13) or placed externally to this latter.

According to some embodiments (not shown), the switching apparatus 200 may comprise a single actuating arrangement 150 operatively coupled to the drive shafts 101 of the switching units through suitable gear mechanisms.

The switching unit 1, according to the present disclosure, allow achieving the intended aim and objects.

The switching unit, according to the present disclosure, includes an innovative drive assembly 100 for operating the movable contacts 3 of a pair of switching poles electrically connected in series during a closing maneuver or opening maneuver.

The drive assembly comprises eccentric mechanisms 106 to mechanically coupled a rotating drive shaft 101 to the pushrods 5 of the switching poles, which are in turn operatively coupled to the movable contacts 3.

The solution of the present disclosure allows reducing drastically the intensity of lateral force components on the pushrods of the switching poles during a closing maneuver or opening maneuver of the switching unit in comparison to traditional solutions of the state of the art.

The switching unit of the present disclosure thus provides relevant advantages with respect to corresponding known systems of the state of the art.

Thanks to the reduction of lateral force components exerted on the pushrods 5, the moving elements of the switching poles are less subject to wear phenomena, which allows prolonging their operating life.

Additionally, lower torque levels of the drive shaft are needed to actuate the movable contacts 3 of the switching poles, which allows reducing the overall mechanical energy levels needed to operate the switching poles.

As the switching unit is less subject to vibrations and backslashes, lighter and less cumbersome fixation arrangements are needed to fix the switching unit on a suitable supporting structure. The switching unit is thus relatively easy to install in the field even if relatively small installation spaces are available.

The switching unit, according to the present disclosure, has a relatively simple structure, which is particularly easy to assembly at industrial level.

The switching unit, according to the present disclosure, can thus be manufactured at competitive industrial costs compared to the available solutions of the state of the art.

The disclosed systems and methods are not limited to the specific embodiments described herein. Rather, components of the systems or activities of the methods may be utilized independently and separately from other described components or activities.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

1. A switching unit comprising a pair of switching poles electrically connected in series, each switching pole comprising:
first and second pole terminals;
a vacuum interruption chamber including a fixed contact electrically connected to said first pole terminal and a movable contact electrically connected to said second pole terminal, wherein said movable contact is movable along a translation axis between an open position, in which it is separated from the fixed contact, and a closed position, in which it is electrically coupled to the fixed contact;
a motion transmission assembly placed outside said vacuum interruption chamber and operatively coupled to said movable contact;
a pushrod operatively coupled to said motion transmission assembly; and
a drive assembly comprising:
a drive shaft configured to rotate about a rotation axis during a closing maneuver or an opening maneuver of said switching unit; and
a plurality of eccentric mechanisms, wherein:
each eccentric mechanism is operatively coupled to said drive shaft and to the pushrod of a switching pole, and
each eccentric mechanism is actuated by rotational mechanical forces provided by said drive shaft and provides corresponding translational mechanical forces to the pushrod of a switching pole to actuate the movable contact of said switching pole during a closing maneuver or an opening maneuver of said switching unit.

2. The switching unit according to claim 1, wherein:
each eccentric mechanism is movable, upon actuation by said drive shaft, between a first end-of-run position, at which said movable contact is in said open position, and a second end-of-run position, at which said movable contact is in said closed position and under a mechanical load that forces said movable contact against said fixed contact,
said eccentric mechanism reaches said first end-of-run position at the end of an opening maneuver of said switching unit and stably maintains said first end-of-run position until a closing maneuver of said switching unit is carried out, even if said eccentric mechanism is not actuated by said drive shaft, and
each eccentric mechanism reaches said second end-of-run position at the end of a closing maneuver of said switching unit and stably maintains said second end-of-run position until an opening maneuver of said switching unit is carried out, even if said eccentric mechanism is not actuated by said drive shaft.

3. The switching unit according to claim 2, wherein said drive assembly comprises a first end-of-run element in a fixed position and a second end-of-run element mechanically coupled with said drive shaft so as to rotate solidly with said drive shaft, and
wherein said second end-of-run element abuts against said first end-of-run element, when said eccentric mechanisms reach said first end-of-run position or said second end-of-run position.

4. The switching unit according to claim 2, wherein, during an opening maneuver or a closing maneuver of said switching apparatus, each eccentric mechanism passes through a first deadlock position, at which said movable contact is decoupled from said fixed contact and reaches a point of maximum distance from said fixed contact, and passes through a second deadlock position, at which said movable contact is in said closed position and under a maximum mechanical load that forces said movable contact against said fixed contact.

5. The switching unit according to claim 4, wherein, during a closing maneuver of said switching apparatus, each eccentric mechanism leaves said first end-of-run position, at which said movable contact is in said open position and is spaced from said fixed contact by a distance which is shorter than said maximum distance, passes trough said first deadlock position, passes through said second deadlock position and reaches said second end-of-run position, at which said movable contact is in said closed position and under a mechanical load, which is lower than said maximum mechanical load.

6. The switching unit according to claim 4, wherein, during an opening maneuver of said switching apparatus, each eccentric mechanism leaves said second end-of-run position, at which said movable contact is in said closed position and under a mechanical load lower than said maximum mechanical load, passes through said second deadlock position, passes through said first deadlock position and reaches said first end-of-run position, at which said movable contact is said open position and is spaced from said fixed contact of a distance which is shorter than said maximum distance.

7. The switching unit, according to claim 1, characterised in that wherein each eccentric mechanism comprises:
an eccentric body coupled with said drive shaft so as to rotate solidly with said drive shaft, wherein said eccentric body has an eccentric axis spaced from said rotation axis and a crank axis passing through said rotation axis and said eccentric axis along a reference plane perpendicular to said rotation axis; and
a lever body operatively coupled with said eccentric body so as to be rotatably movable with respect to said eccentric body, wherein said lever body is hinged to the pushrod of a switching pole at a hinging axis of said lever body, wherein said lever body has a lever axis passing through said hinging axis and said eccentric axis along a reference plane perpendicular to said rotation axis.

8. The switching unit according to claim 7, wherein said crank axis and said lever axis form an angle having an absolute value of lower than or equal to 5° along a plane perpendicular to said rotation axis.

9. The switching unit, according to claim 1, wherein said drive assembly comprises:
a single first eccentric mechanism coupled to the pushrod of a first switching pole; and
a pair of second eccentric mechanisms coupled in parallel to the pushrod of a second switching pole and spaced apart along the rotation axis of said drive shaft, wherein said first eccentric mechanism is arranged in an intermediate position between said second eccentric mechanisms.

10. The switching unit, according to claim 1, wherein said drive assembly comprises:
a pair of first eccentric mechanisms coupled in parallel to the pushrod of a first switching pole and spaced apart one from another along the rotation axis of said drive shaft; and
a pair of second eccentric mechanisms coupled in parallel to the pushrod of a second switching pole and spaced apart along the rotation axis of said drive shaft, wherein said first eccentric mechanisms are arranged in alternate positions with said second eccentric mechanisms along the rotation axis of said drive shaft.

11. A switching apparatus comprising one or more switching units, wherein each switching unit comprises:
a pair of switching poles electrically connected in series, each switching pole comprising:
first and second pole terminals;
a vacuum interruption chamber including a fixed contact electrically connected to said first pole terminal and a movable contact electrically connected to said second pole terminal, wherein said movable contact is movable along a translation axis between an open position, in which it is separated from the fixed contact, and a closed position, in which it is electrically coupled to the fixed contact;
a motion transmission assembly placed outside said vacuum interruption chamber and operatively coupled to said movable contact;
a pushrod operatively coupled to said motion transmission assembly; and
a drive assembly comprising:
a drive shaft configured to rotate about a rotation axis during a closing maneuver or an opening maneuver of said switching unit; and
a plurality of eccentric mechanisms, wherein:
each eccentric mechanism is operatively coupled to said drive shaft and to the pushrod of a switching pole, and
each eccentric mechanism is actuated by rotational mechanical forces provided by said drive shaft and provides corresponding translational mechanical forces to the pushrod of a switching pole to actuate the movable contact of said switching pole during a closing maneuver or an opening maneuver of said switching unit.

12. The switching unit according to claim 3, wherein, during an opening maneuver or a closing maneuver of said switching apparatus, each eccentric mechanism passes through a first deadlock position, at which said movable contact is decoupled from said fixed contact and reaches a point of maximum distance from said fixed contact, and passes through a second deadlock position, at which said movable contact is in said closed position and under a maximum mechanical load that forces said movable contact against said fixed contact.

13. The switching unit according to claim 5, wherein, during an opening maneuver of said switching apparatus, each eccentric mechanism leaves said second end-of-run position, at which said movable contact is in said closed position and under a mechanical load lower than said maximum mechanical load, passes through said second deadlock position, passes through said first deadlock position and reaches said first end-of-run position, at which said movable contact is said open position and is spaced from said fixed contact of a distance which is shorter than said maximum distance.

14. The switching unit according to claim 11, wherein:
each eccentric mechanism is movable, upon actuation by said drive shaft, between a first end-of-run position, at which said movable contact is in said open position, and a second end-of-run position, at which said movable contact is in said closed position and under a mechanical load that forces said movable contact against said fixed contact,
said eccentric mechanism reaches said first end-of-run position at the end of an opening maneuver of said switching unit and stably maintains said first end-of-run position until a closing maneuver of said switching unit is carried out, even if said eccentric mechanism is not actuated by said drive shaft, and
each eccentric mechanism reaches said second end-of-run position at the end of a closing maneuver of said switching unit and stably maintains said second end-of-run position until an opening maneuver of said switching unit is carried out, even if said eccentric mechanism is not actuated by said drive shaft.

15. The switching unit according to claim 14, wherein said drive assembly comprises a first end-of-run element in a fixed position and a second end-of-run element mechanically coupled with said drive shaft so as to rotate solidly with said drive shaft, and
wherein said second end-of-run element abuts against said first end-of-run element, when said eccentric mechanisms reach said first end-of-run position or said second end-of-run position.

16. The switching unit according to claim 14, wherein, during an opening maneuver or a closing maneuver of said switching apparatus, each eccentric mechanism passes through a first deadlock position, at which said movable contact is decoupled from said fixed contact and reaches a point of maximum distance from said fixed contact, and passes through a second deadlock position, at which said movable contact is in said closed position and under a maximum mechanical load that forces said movable contact against said fixed contact.

17. The switching unit according to claim 16, wherein, during a closing maneuver of said switching apparatus, each eccentric mechanism leaves said first end-of-run position, at which said movable contact is in said open position and is spaced from said fixed contact by a distance which is shorter than said maximum distance, passes through said first deadlock position, passes through said second deadlock position and reaches said second end-of-run position, at which said movable contact is in said closed position and under a mechanical load, which is lower than said maximum mechanical load.

18. The switching unit according to claim 16 wherein, during an opening maneuver of said switching apparatus, each eccentric mechanism leaves said second end-of-run position, at which said movable contact is in said closed position and under a mechanical load lower than said maximum mechanical load, passes through said second deadlock position, passes through said first deadlock position and reaches said first end-of-run position, at which said movable contact is said open position and is spaced from said fixed contact of a distance which is shorter than said maximum distance.

19. The switching unit, according to claim 11, wherein each eccentric mechanism comprises:
an eccentric body coupled with said drive shaft so as to rotate solidly with said drive shaft, wherein said eccentric body has an eccentric axis spaced from said rotation axis and a crank axis passing through said rotation axis and said eccentric axis along a reference plane perpendicular to said rotation axis; and
a lever body operatively coupled with said eccentric body so as to be rotatably movable with respect to said eccentric body, wherein said lever body is hinged to the pushrod of a switching pole at a hinging axis of said lever body, wherein said lever body has a lever axis passing through said hinging axis and said eccentric axis along a reference plane perpendicular to said rotation axis.

20. The switching unit according to claim 19, wherein said crank axis and said lever axis form an angle having an absolute value of lower than or equal to 5° along a plane perpendicular to said rotation axis.
